(19) United States
(12) Patent Application Publication
(10) Pub. No.: US 2006/0237329 A1
(43) Pub. Date: Oct. 26, 2006

(54) CHEMICAL ETCH ASSISTED SPARK MACHINING HEAD

(75) Inventor: Gilles Rey-Mermet, Le Landeron (CH)

Correspondence Address: GRIFFIN & SZIPL, PC, SUITE PH-1, 2300 NINTH STREET, SOUTH, ARLINGTON, VA, 22204, US

(73) Assignee: Asulab S.A., Marin (CH)

(21) Appl. No.: 11/379,898

(22) Filed: Apr. 24, 2006

(30) Foreign Application Priority Data
Apr. 22, 2005 (EP) 05008851.7
Aug. 26, 2005 (EP) 05018632.9

(51) Int. Cl. B23H 3/00

(52) U.S. Cl. 205/640

(57) ABSTRACT

The present invention concerns a chemical etch assisted spark machining head, characterized in that it includes a body through which an electrode extends and which defines a counter-electrode extending radially around the electrode, said body including means for feeding an electrolytic liquid into the space delimited by the electrode and the counter-electrode.

This application claims priority from European Patent Applications No. 05008851.7 filed Apr. 22, 2005 and No. 05018632.9 filed Aug. 26, 2005. The entire disclosures of the above patent applications are hereby incorporated by reference.

### FIELD OF THE INVENTION

The present invention concerns a chemical etch assisted spark machining head. The present invention concerns in particular a head of this type for machining holes in non electrically conductive materials such as glass sheets.

### BACKGROUND OF THE INVENTION

It was in 1968 that the use of electric discharges arising from an electrochemical reaction in an electrolyte for drilling holes of small dimensions in glass sheets was first disclosed. Such a known method has been improved since that date. In its current form, the method consists in immersing the glass sheet to be machined into an electrolytic bath formed, for example, of a 30% concentration of caustic soda NaOH. A constant voltage typically comprised between 25V and 40V is applied between the etching instrument, which forms a cathode electrode, and an anode counter-electrode in contact with the electrolyte but at a distance from the working zone. Hydrogen bubbles that are formed on the etching instrument are concentrated via coalescence and form a gaseous film covering the electrode. Electric discharges appearing inside the film erode the glass locally.

The method described above has the drawback of requiring immersion of the whole surface of the part that has to be machined in the electrolyte. A liquid like caustic soda is very corrosive and particularly dangerous if splashed in the eyes. During industrialisation where parts of large dimensions with a broad surface have to be treated, this method would require baths of large volume to be used and large quantities of electrolyte to be handled, which makes implementation of this method critical and dangerous.

A method and a device for drilling holes in a glass sheet by means of electrochemical discharges are known from Japanese Patent No. JP 92-34629 in the name of Nippon Sheet Glass Corp. Ltd. The device essentially includes a working electrode in the form of a rectilinear bar surrounded by a ring-shaped counter electrode placed flush with the glass sheet to be machined. A tubular pipe drips the electrolyte into the annular space defined by the counter-electrode. The excess electrolyte flows over the top of the edge of the counter-electrode and is evacuated towards a tank on the top surface of which there is arranged the glass sheet to be machined.

The device described above advantageously means that the whole of the glass sheet to be machined does not have to be immersed in an electrolyte bath and thus reduces the quantity of electrolyte used. The risk of the electrolyte splashing is thus limited. It is however only an experimental device that is difficult to transfer to an industrial scale. Indeed, it is difficult to imagine how the assembly formed by the electrode and the counter-electrode could be moved in order to machine holes in other places on the glass sheet. Conversely, one could envisage moving the glass sheet while keeping the electrode/counter-electrode assembly stationary. This solution is not very convenient either since it would involve wasting electrolyte during the relative movement of the glass sheet in relation to the counter-electrode.

It is an object of the present invention to overcome the aforementioned drawbacks in addition to others by providing a machining head that allows glass sheets of large dimensions to be treated at a rate compatible with industrial requirements while optimising the use of the electrolyte and minimising the dispersion thereof in the working zone.

### SUMMARY OF THE INVENTION

The present invention therefore concerns a chemical etch assisted spark machining head, characterized in that it includes a body through which there extends an electrode and which defines a counter-electrode extending radially around the electrode, the body including means for feeding an electrolytic liquid into the space delimited by the electrode and the counter-electrode.

Owing to these features, the present invention provides a chemical etch assisted spark machining head, essentially formed by a body which is capable of being moved in three dimensions. One can thus envisage machining large sheets of glass while keeping them immobile and just moving the machining head with precision, which confers great flexibility of use to the machining head according to the invention. Moreover, the electrolytic liquid is confined in the volume delimited by the counter-electrode which extends radially around the electrode, such that the quantities of electrolyte used are low and the risk of said electrolyte splashing is reduced.

According to a complementary feature of the invention, the machining head also includes means for evacuating the electrolytic liquid after use.

This feature guarantees even more secure use of the machining head according to the invention in that the electrolytic liquid is evacuated immediately after use. Any risk of contact with the electrolytic liquid is thus avoided. Moreover, the forced flow of the electrolyte leads to permanent renewal of the latter in the working zone and thereby ensures excellent stability of the physico-chemical parameters of the spark machining method.

According to another feature of the invention, the electrolyte evacuation flow rate is greater than the electrolyte feed flow rate.

It is thus possible to evacuate, not only the used electrolyte but also the gases produced by the machining method. Moreover, if the glass sheet to be machined is immersed in water, the water present in proximity to the working zone will be evacuated at the same time as the used electrolyte, such that the bath water remains constantly clean.

According to a preferred embodiment of the invention, the counter-electrode has the shape of a revolution part arranged around the electrode, a last exterior part assuring the confinement of the electrolyte upon extraction and having no electric function. In the machining head of the invention, the electrolyte is only present in immediate proximity to the working zone defined by the end of the electrode opposite the glass sheet to be machined. The counter-electrode must therefore be in proximity to the working electrode, otherwise it cannot perform its electrochemical function. Thus, by virtue of its shape of revolution, the counter-electrode is very close to the electrode and thus performs the function of confining and monitoring the flow of electrolytic liquid around the working zone.

### BRIEF DESCRIPTION OF THE DRAWINGS

Other features and advantages of the present invention will appear more clearly in the following detailed description of an embodiment of the machining head according to the present invention, this example being given solely by way of non-limiting illustration in conjunction with the annexed drawing, in which:

FIG. 1 is a perspective view from a first angle of the machining head according to the invention;

FIG. 2 is a perspective view from a second angle different to the first of the machining head according to the invention;

FIG. 3 is a perspective exploded view of the machining head according to the invention;

FIG. 4 is an elevation view of the machining head according to the invention;

FIG. 5 is a top view of the machining head shown in FIG. 4;

FIG. 6 is a cross-section of the machining head according to the invention;

FIG. 7 is another perspective view of the machining head according to the invention;

FIG. 8 is a schematic diagram of the machining head connected to a pump and to a control and monitoring computer, and

FIGS. 9A to 9C show various embodiments of the working electrode.

### DETAILED DESCRIPTION OF THE ILLUSTRATIVE EMBODIMENTS

The present invention proceeds from the general inventive idea which consists in providing a chemical etch assisted spark machining head able to be moved in three dimensions, which enables large glass sheets to be machined easily and precisely and at rates compatible with industrial scale production. Moreover, in the preferred variant of the invention, the machining head is provided with means for feeding and evacuating the electrolytic liquid, which enables the quantities of electrolyte used to be reduced and avoids any risk of splashing the electrolyte.

The present invention will be described in relation to the machining of holes or cavities in glass sheets. It goes without saying that the invention is not limited to this material and that it can apply to drilling holes in any type of non electrically conductive material such as plastic materials, ceramics or semi conductor materials.

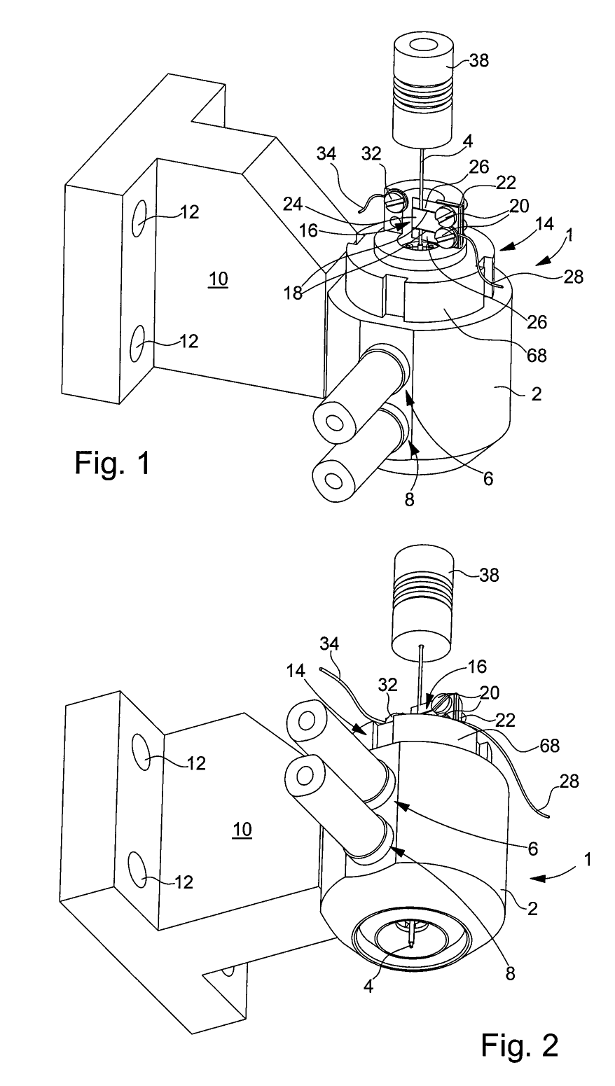

FIGS. 1 and 2 annexed hereto show a machining head according to the present invention and designated as a whole by the general reference numeral 1. This machining head 1 includes a body 2 through which a working electrode 4 extends. Body 2 is provided with means for feeding 6 and means for evacuating 8 an electrolytic fluid such as caustic soda NaOH. Body 2 of machining head 1 is connected to the frame of a three-axis machine (not shown) via a fixing bracket 10. For this purpose fixing bracket 10 includes through holes 12 for assembly via screws.

According to a simplified variant of the invention, body 2 forms the anodic counter-electrode of machining head 1 according to the invention.

According to the preferred embodiment of the invention, the counter-electrode is a part of revolution shape 14 which takes the form of a hollow cylinder. It is distinct from body 2 in which it is engaged and it is arranged radially around working electrode 4. At its tip, counter-electrode 14 is partially truncated to allow it to be electrically connected to a voltage source.

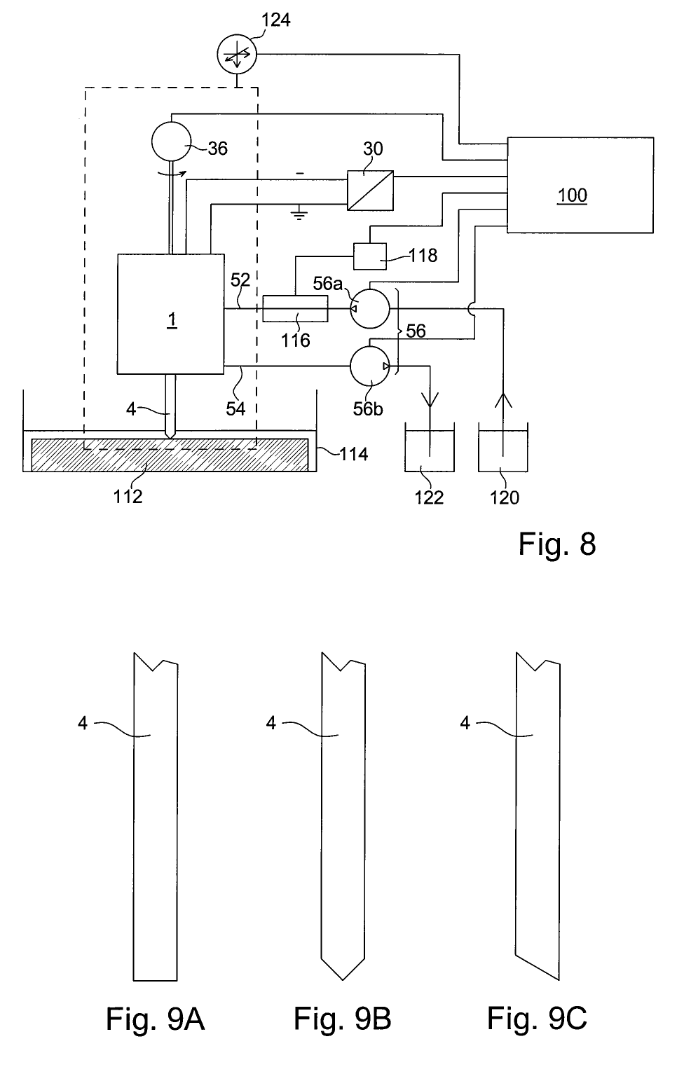

As will be seen hereinafter, working electrode 4 has to be able to rotate about itself while being electrically connected to the same voltage source as counter-electrode 14. A simple solution consists in providing a contact strip 16 having two rectilinear slots 18 and mounted on counter-electrode 14, for example screwed on via screws 20. An insulating plate 22 is arranged between contact strip 16 and counter-electrode 14 to prevent any short-circuiting between the two parts. The two rectilinear slots 18 made in contact strip 16 split the latter into three branches, the median branch 24 of which is wider than the two ends branches 26. The working electrode 4, which takes the form of a rectilinear rod, is passed over the top of end branches 26 and under median branch 24 of contact strip 16 so as to slightly pinch and form an electric contact via friction between said electrode 4 and said contact strip 16. Screws 20 which are sued for securing contact strip 16 onto counter-electrode 14 can also be used for securing an electric connection wire 28 for connecting working electrode 4 to an electric power source 30 (see FIG. 8).

Likewise, a screw 32 directly screwed into counter-electrode 14 can be used to connect the latter to power source 30 via an electric wire 34.

Finally, working electrode 4 can be driven in rotation via a motor 36 (see FIG. 8) owing to a coupling piece 38.

Working electrode 4 is a cylindrical rectilinear rod that can be made, for example, of stainless steel or even of tungsten. This latter material has the advantage of being an excellent conductor of electricity, of having a high melting temperature and having good chemical resistance. The diameter of working electrode 4 is advantageously comprised between 0.1 mm and 1 mm. Counter-electrode 14 is for example made of nickel plated steel in order to resist corrosion.

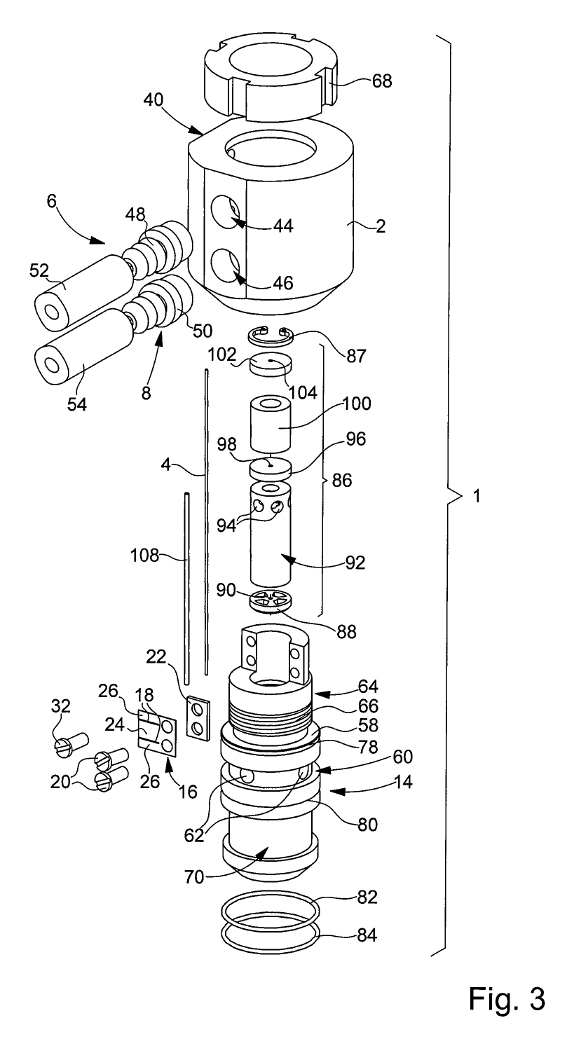

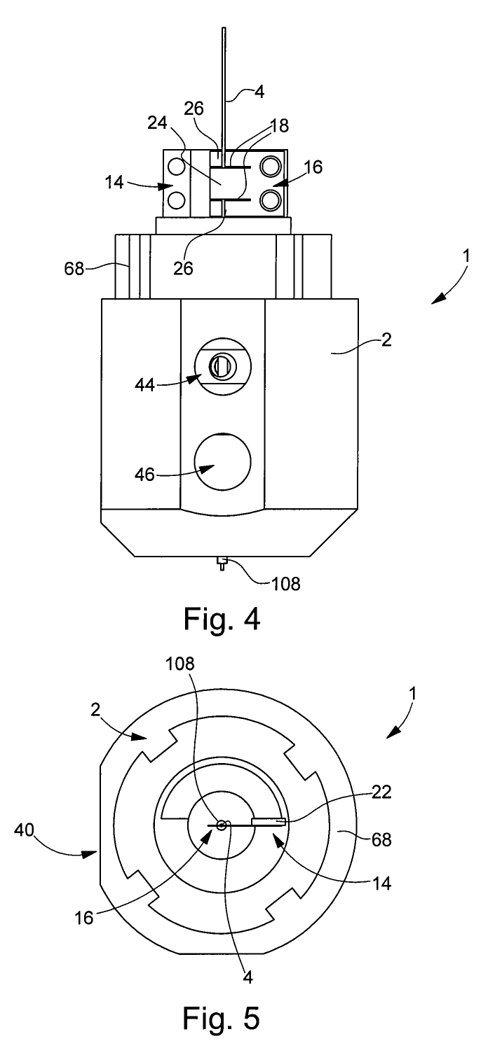

We will now discuss the detail of the structure of machining head 1 according to the invention with reference to FIGS. 3 to 7.

Body 2 of machining head 1 is a substantially cylindrical hollow part having a flat portion 40 for mounting a fixing bracket 10. For this purpose, flat portion 40 has two holes 42 for screwing in said bracket 10. Body 2 is pierced with two holes 44 and 46 which open into its inner volume and which are used for mounting two inlets 48 and 50 to which a feed pipe 52 and an evacuation pipe 54 for the electrolytic liquid are respectively fixed. These pipes 52 and 54 are connected to a pump 56 as will be described in detail hereinafter with reference to FIG. 8.

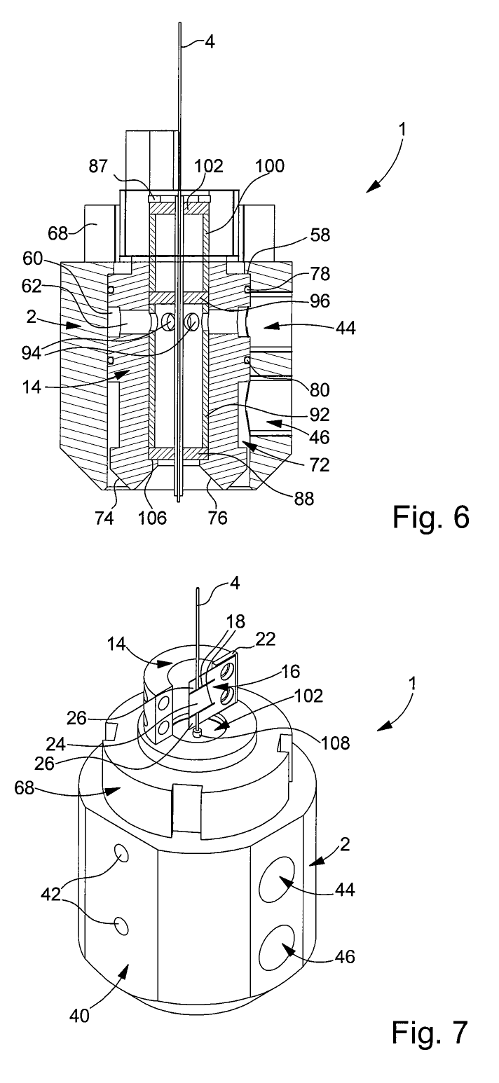

Body 2 is axially engaged on counter-electrode 14 which is also a substantially cylindrical hollow part. Body 2 is immobilised axially on counter-electrode 14 abutting against an annular shoulder 58 provided towards the top end of counter-electrode 14 (see FIG. 6). At one place on its height, counter-electrode 14 has a circular groove 60 where one, and preferably several regularly spaced through holes 62 are made, which open into the inner volume of said counter-electrode 14. These through holes 62 are provided at a height such that when body 2 is immobilized axially on counter-electrode 14, hole 44 made in said body 2 and through which the electrolytic liquid arrives is at the same level as said through holes 62. The electrolytic liquid can thus flow along circular groove 60 and penetrate the inner volume of counter-electrode 14 via the plurality of through holes 62. The plurality of through holes 62 thus allows the electrolyte to flow better. Moreover, it is not necessary to index the position of counter-electrode 14 inside body 2 to ensure that the electrolyte feed hole 44 is opposite a single hole 62 which would be machined in counter-electrode 14.

Counter-electrode 14 is higher than body 2. The part 64 of counter-electrode 14 that projects from body 2 can have an external threading 66 for screwing in a locking nut 68 which forces body 2 against counter-electrode 14 and immobilises it.

Towards its base, counter-electrode 14 has a reduced diameter 70 which, with the inner wall of body 2, defines an annular chamber 72 in communication with hole 46 arranged through the thickness of said body 2 for the evacuation of the electrolytic liquid.

At its base, counter-electrode 14 has a circular edge 74 inclined outwards and a circular edge 76 inclined inwards. In its simplified embodiment, the circular edge of counter-electrode 14 could be flat. Nonetheless, this would make evacuation of the electrolytic liquid by suction more difficult. This is why the external inclined edge 74 is provided, which leaves a larger space free for the passage of the electrolyte. Likewise, inner edge 76 is also inclined in order to offer the electrical field lines that are set up between electrode 4 and counter-electrode 14 as large a surface as possible over which to be distributed to prevent tip phenomena. It is desirable to prevent an excessive concentration of field lines on the counter-electrode where the spark electrochemical reaction could occur.

Finally, counter-electrode 14 has two circular grooves 78 and 80 in which two sealing gaskets 82 and 84 are housed. The function of these two sealing gaskets 82 and 84 is to prevent the electrolytic liquid arriving through feed hole 44 from rising and descending inside machining head 1.

It may be difficult to machine a long hole of small diameter in counter-electrode 14 for the insertion of electrode 4. This is why a hole of larger diameter is preferably machined in counter-electrode 14 into which a guide assembly 86 for electrode 4 will be axially inserted. The guide assembly 86 is composed, in succession and from bottom to top, of a cut out base disc 88 through which the electrolytic liquid can escape and at the centre of which a hole 90 is provided for the passage of electrode 4, of a first intermediate tube 92 which is used as a spacer and which has, at one place on its height, a plurality of through holes 94 opposite holes 62 of counter-electrode 14 and hole 44 of body 2 for the passage of the electrolyte, of a circular intermediate spacer 96 pierced with only one central hole 98 for the passage and guiding of electrode 4 and which thus prevents the electrolytic liquid from rising up, a second intermediate tube 100 which is used only as a spacer, and of a top circular spacer 102 pierced with only one central hole 104 for guiding electrode 4. The guiding assembly 84 is blocked axially inside counter-electrode 14 by its base disc 88 which abuts against a shoulder 106 arranged at the base of the inner surface of said counter-electrode 14 and by a resilient ring 87 which is housed in a circular groove made in the inner wall of counter-electrode 14.

Finally, electrode 4 is axially inserted inside guide assembly 86. Electrode 4 thus extends concentrically inside the guide assembly 86 which itself extends concentrically inside counter-electrode 14 which itself extends concentrically inside body 2.

According to a preferred embodiment of the invention, working electrode 4 is insulated from the electrolyte by being introduced into a sleeve 108 made of a non-conductive material such as glass and only the end part of electrode 4 in immediate proximity to the working zone is exposed. This thus guarantees that the ratio between the surface area of working electrode 4 in contact with the electrolyte and the surface area of counter-electrode 14 in contact with the same electrolyte is sufficiently low, typically of the order of 1:100, so that machining head 1 according to the invention can be made in sufficiently small dimensions. Other methods for insulating the working electrode 4 from the electrolytic liquid could be envisaged. One could, for example, deposit an electrically non-conductive chemical etch resistant coating such as Teflon® directly on electrode 4. Electrode 4 thus coated could then be introduced into a metal tube.

FIG. 8 is a schematic diagram of machining head 1 connected to pump 56 and to a control and monitoring computer 110. The glass sheet 112 to be machined is arranged in a working tank 114 which can advantageously be filled with water. The electrical power source 30 applies a difference in potential between electrode 4 and counter-electrode 14. Advantageously, counter-electrode 14 is connected to earth and the difference in potential between the anodic electrode 4 and the cathodic counter-electrode 14 is approximately −30V. Two distinct pumps can be provided: one for feeding the electrolytic liquid to machining head 1 and one for evacuating the used electrolyte. However, preferably, a single peristaltic pump 56 will be used comprising two stages 56a and 56b respectively connected to feed pipe 52 and to evacuation pipe 54 for the electrolytic liquid.

Machining is quicker when the electrolytic liquid is preheated. In fact, the start of machining can be delayed by several tens of seconds when the electrolyte is cold, which raises obvious problems for the industrial use of machining head 1 according to the invention. Machining head 1 can easily be adapted to feed the preheated electrolyte directly into machining head 1. Either a heating body can be provided directly integrated in machining head 1 or, as shown in FIG. 8, a heating body 116 is provided outside machining head 1 but arranged in proximity thereto, on the electrolyte feed pipe 52, to prevent thermal losses between the place where said electrolyte is heated and the working zone. The heating body 116 is connected to a power supply 118 regulated by computer 100. In order to regulate the temperature of the electrolyte, a heat sensor can advantageously be arranged in machining head 1.

Stage 56a of peristaltic pump 54 takes the electrolytic fluid into a tank 120 whereas stage 56b of said pump 56 evacuates the used electrolyte to a tank 122.

Motor 36, controlled by computer 100, drives the working electrode 4 in rotation. This driving in rotation ensures more regular machining and better flow of the electrolyte in the area of the working zone. Finally, the machining head assembly 1 which is inscribed within a rectangle shown in dotted lines in FIG. 8 can be moved in three dimensions by means of a three axis machine 124 that is also controlled by computer 100. Advantageously, electrode 4 and its glass sleeve 108 can retract inside machining head 1. This means that said electrode 4 and its sleeve 100 will not be broken if the machining head descends too quickly. One could also envisage measuring the movement or the force exerted on the assembly formed by electrode 4 and its sleeve 108 inside machining head 1 in order to adapt the speed of descent of the latter to the hole drilling speed.

The used electrolyte evacuation flow rate can be greater than the electrolyte feed flow rate in the working zone. This difference in flow rate can be obtained by choosing electrolyte feed and evacuation pipes 52 and 54 of different diameters. The gases generated by the machining process are thus evacuated and the water in which the glass sheet that has to be machined is immersed remains clean, since in addition to the used electrolyte, a small quantity of polluted water is evacuated.

Three alternative embodiments of the end of working electrode 4 can be envisaged. According to the first variant illustrated in FIG. 9A, electrode 4 has a flat end. This geometry guarantees that the bottom of the machined hole will be flat. It is not, however, optimum from the point of view of field line concentration. This problem is overcome with the variant illustrated in FIG. 9B in which the end of working electrode 4 is cut into a point. The field lines are concentrated by tip effect. Nonetheless, the bottom of the machined hole will have a cone shape complementary to that of the end of electrode 4. A third variant illustrated in FIG. 9C provides a bevelled end of the working electrode. The tip effect, which concentrates the field lines, is advantageously combined with the possibility of obtaining a flat bottomed hole when electrode 4 is driven in rotation.

It goes without saying that the present invention is not limited to the embodiment that has just been described and that various simple alterations and variants can be envisaged by those skilled in the art without departing from the scope of the invention as defined by the annexed claims. In particular, a heated pencil type element could be introduced into body 2 or into counter-electrode 14. Another solution could consist in placing the heating body in the space comprised between the sleeve 108 and tube 92, while providing sealed passages in discs 96 and 102. Yet another solution could consist in placing a heating body all around body 2.

1. A chemical etch assisted spark machining head, comprising a body through which an electrode extends and which defines a counter-electrode, extending radially around the electrode, said body including means for feeding an electrolytic liquid into the space delimited by the electrode and the counter-electrode.

2. A chemical etch assisted spark machining head, comprising a counter-electrode arranged radially around an electrode and axially engaged inside a body, said body including means for feeding an electrolytic liquid into the space delimited by the electrode and the counter-electrode.

3. The machining head according to claim 1, further comprising means for evacuating the electrolytic liquid after use.

4. The machining head according to claim 2, further comprising means for evacuating the electrolytic liquid after use.

5. The machining head according to claim 3, wherein an electrolyte evacuation flow rate is greater than a feed flow rate of said electrolyte.

6. The machining head according to claim 4, wherein an electrolyte evacuation flow rate is greater than a feed flow rate of said electrolyte.

7. The machining head according to claim 1, further comprising a guide assembly for the electrode that is axially disposed into the counter-electrode.

8. The machining head according to claim 2, further comprising a guide assembly for the electrode that is axially disposed into the counter-electrode.

9. The machining head according to claim 7, wherein at least one through hole for feeding the electrolytic liquid is pierced in the body, said hole communicating with at least one through hole made in the counter-electrode which itself communicates with at least one through hole made in the guide assembly for the electrode.

10. The machining head according to claim 8, wherein at least one through hole for feeding the electrolytic liquid is pierced in the body, said hole communicating with at least one through hole made in the counter-electrode which itself communicates with at least one through hole made in the guide assembly for the electrode.

11. The machining head according to claim 9, wherein a second hole is pierced in the body for evacuating the electrolytic liquid, said hole communicating with an annular space delimited by said body and the counter-electrode.

12. The machining head according to claim 10, wherein a second hole is pierced in the body for evacuating the electrolytic liquid, said hole communicating with an annular space delimited by said body and the counter-electrode.

13. The machining head according to claim 9, wherein the guide assembly includes at least one cut out base disc having at the centre thereof a hole for the passage of the electrode and an intermediate spacer pierced with only a central hole for the passage and guiding of the electrode, and further comprising an intermediate tube in which the said at least one through hole is pierced, disposed between the base disc and the intermediate spacer.

14. The machining head according to claim 10, wherein the guide assembly includes at least one cut out base disc having at the centre thereof a hole for the passage of the electrode and an intermediate spacer pierced with only a central hole for the passage and guiding of the electrode, and further comprising an intermediate tube in which the said at least one through hole is pierced disposed between the base disc and the intermediate spacer.

15. The machining head according to claim 11, wherein the guide assembly includes at least one cut out base disc having at the centre thereof a hole for the passage of the electrode and an intermediate spacer pierced with only a central hole for the passage and guiding of the electrode, and further comprising an intermediate tube in which the said at least one through hole is pierced, disposed between the base disc and the intermediate spacer.

16. The machining head according to claim 12, wherein the guide assembly includes at least one cut out base disc having at the centre thereof a hole for the passage of the electrode and an intermediate spacer pierced with only a central hole for the passage and guiding of the electrode, and further comprising an intermediate tube in which the said at least one through hole is pierced, disposed between the base disc and the intermediate spacer.

17. The machining head according to claim 1, wherein the electrode is a cylindrical rod.

18. The machining head according to claim 2, wherein the electrode is a cylindrical rod.

19. The machining head according to claim 17, wherein the end of the electrode is flat, cut into a point or bevelled.

20. The machining head according to claim 18, wherein the end of the electrode is flat, cut into a point or bevelled.

21. The machining head according to claim 17, wherein the diameter of the electrode is between 0.1 mm and 1 mm.

22. The machining head according to claim 18, wherein the diameter of the electrode is between 0.1 mm and 1 mm.

23. The machining head according to claim 19, wherein the diameter of the electrode is between 0.1 mm and 1 mm.

24. The machining head according to claim 20, wherein the diameter of the electrode is between 0.1 mm and 1 mm.

25. The machining head according to claim 1, wherein the electrode is insulated so as to only be in contact with the electrolyte in the lower end portion thereof.

26. The machining head according to claim 2, wherein the electrode is insulated so as to only be in contact with the electrolyte in the lower end portion thereof.

27. The machining head according to claim 25, wherein the electrode is disposed in an electrically insulating sleeve.

28. The machining head according to claim 26, wherein the electrode is disposed in an electrically insulating sleeve.

29. The machining head according to claim 25, wherein the electrode is coated with an electrically non-conductive coating resistant to etching by an electrolytic product.

30. The machining head according to claim 26, wherein the electrode is coated with an electrically non-conductive coating resistant to etching by an electrolytic product.

31. The machining head according to claim 27, wherein the electrode is also disposed in a metal tube.

32. The machining head according to claim 28, wherein the electrode is also disposed in a metal tube.

33. The machining head according to claim 17, wherein the electrode is made of stainless steel or tungsten.

34. The machining head according to claim 18, wherein the electrode is made of stainless steel or tungsten.

35. The machining head according to claim 1, further comprising means for heating the electrolyte prior to use.

36. The machining head according to claim 2, further comprising means for heating the electrolyte prior to use.

37. The machining head according to claim 1, wherein a heating body is arranged on a pipe feeding the electrolyte to the machining head.

38. The machining head according to claim 2, wherein a heating body is arranged on a pipe feeding the electrolyte to the machining head.

39. The machining head according to claim 1, wherein the counter-electrode has at its base a circular edge inclined inwards.

40. The machining head according to claim 2, wherein the counter-electrode has at its base a circular edge inclined inwards.

41. The machining head according to claim 39, wherein the counter-electrode also has at its base a circular edge inclined outwards.

42. The machining head according to claim 40, wherein the counter-electrode also has at its base a circular edge inclined outwards.

43. The machining head according to claim 1, further comprising two pipes for feeding and evacuating the electrolyte, said two pipes being connected at a first end to the through holes and at a second end to the two stages of a peristaltic pump.

44. The machining head according to claim 2, further comprising two pipes for feeding and evacuating the electrolyte, said two pipes being connected at a first end to through holes and at a second end to two stages of a peristaltic pump.

45. The machining head according to claim 1, wherein the electrode is drivable in rotation.

46. The machining head according to claim 2, wherein the electrode is drivable in rotation.

47. The machining head according to claim 1, wherein the electrode is able to move axially.

48. The machining head according to claim 2, wherein the electrode is able to move axially.

49. The machining head according to claim 47, further comprising means for measuring the axial movement or axial force exerted on the electrode.

50. The machining head according to claim 48, further comprising means for measuring the axial movement or axial force exerted on the electrode.
